(19) United States
(12) Patent Application Publication
(10) Pub. No.: US 2024/0330007 A1
(43) Pub. Date: Oct. 3, 2024

(54) CONTROL METHOD FOR INFORMATION PROCESSING APPARATUS AND NON-VOLATILE STORAGE MEDIUM

(71) Applicant: CANON KABUSHIKI KAISHA, Tokyo (JP)

(72) Inventors: TAKAHIRO HAYAMA, Tokyo (JP); HIROYOSHI IWAYAMA, Kanagawa (JP)

(21) Appl. No.: 18/617,761

(22) Filed: Mar. 27, 2024

(30) Foreign Application Priority Data
Mar. 30, 2023 (JP) 2023-056355

(51) Int. Cl. G06F 9/4401

(52) U.S. Cl. CPC G06F 9/4406

(57) ABSTRACT

A control method for an information processing apparatus in which an application that is configured to operate on an operating system (OS) and has a function concerning a setting for function execution of external equipment, the method comprising obtaining information concerning a first language set for the application, and executing language setting for the external equipment by using the obtained information of the first language set for the application in setting for the function execution.

### BACKGROUND OF THE INVENTION

### Field of the Invention

The present invention mainly relates to a control method for an information processing apparatus.

### Description of the Related Art

Japanese Patent Laid-Open No. 10-275071 discloses a technique for preventing character corruption, confusion, and the like that can occur in a case where an operating system (OS) and an application program (application) differ in set language.

Some of information processing apparatuses that include OSs and can communicate with external equipment allow installation of an application for the utilization of external equipment. The user can make external equipment execute a predetermined function by using an application from such an information processing apparatus. In such a case, the user may not properly obtain a desired product depending on the settings in the external equipment. Accordingly, there is room for improvement in the configurations disclosed in Japanese Patent Laid-Open No. 10-275071 from the viewpoint of improvement in the usability of an information processing apparatus that can communicate with external equipment.

### SUMMARY OF THE INVENTION

The present invention has been made upon recognition of the above problem by the present inventor and has as its object to provide a technique advantageous in improving the usability of an information processing apparatus that can communicate with external equipment.

One of the aspects of the present invention provides a control method for an information processing apparatus in which an application that is configured to operate on an operating system (OS) and has a function concerning a setting for function execution of external equipment, the method comprising obtaining information concerning a first language set for the application, and executing language setting for the external equipment by using the obtained information of the first language set for the application in setting for the function execution.

Further features of the present invention will become apparent from the following description of exemplary embodiments (with reference to the attached drawings).

### BRIEF DESCRIPTION OF THE DRAWINGS

FIGS. 1A and 1B are block diagrams showing an example of the configuration of an information processing apparatus according to an embodiment;

FIG. 2 is a block diagram showing an example of the configuration of a terminal apparatus (external equipment);

FIG. 3 is a flowchart showing an example of the processing for performing language setting for the terminal apparatus;

FIG. 4 is a schematic view of a dialog screen displayed on a display unit;

FIG. 5 is a view showing an example of an OS setting screen; and

FIG. 6 is a view showing an example of a display screen of function execution applications.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

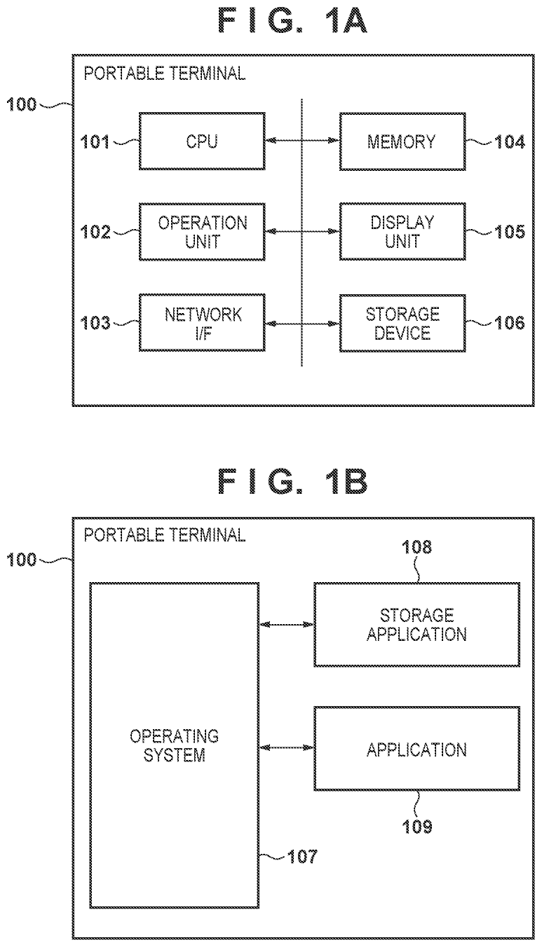

FIG. 1A shows an example of the hardware configuration of a portable terminal 100 as an information processing apparatus according to an embodiment. FIG. 1B shows an example of the software configuration of the portable terminal 100.

In this case, the following will exemplify the portable terminal 100 as an information processing apparatus. However, the information processing apparatus is not limited to this as long as it is a known electronic apparatus in which programs can be installed. In this case, a smartphone is presented as the portable terminal 100. The smartphone can include various types of functions such as a mail function, a camera function, and an interface browser function in addition to a telephone function. Other examples of the portable terminal 100 include a notebook personal computer, a tablet terminal, a personal digital assistant (PDA), a digital camera, a music playback device, and a TV set.

As shown in FIG. 1A, the portable terminal 100 includes a central processing unit (CPU) 101, an operation unit 102, a network interface 103, a memory 104, a display unit 105, and a storage device 106. These components are connected to each other via a system bus. The CPU 101 controls the overall system of the portable terminal 100.

The operation unit 102 is configured to accept an operation input from the user with respect to the portable terminal 100 and includes, for example, button type switches and a touch panel. The user can issue a desired instruction to the portable terminal 100 via the operation unit 102.

The network interface 103 is an interface for connection to a network. This allows the portable terminal 100 to communicate with external equipment such as a printer. For example, when the user uses the function of external equipment by using the portable terminal 100, a signal corresponding to an operation input to the operation unit 102 can be transmitted to the external equipment via the network interface 103.

The memory 104 is a random access memory (RAM) as a work area of the CPU 101. This memory temporarily holds received data and holds set data for executing a corresponding function. The storage device 106 is, for example, a flash memory and holds control programs such as an operating system (to be referred to as an “OS” hereinafter) and an application program (to be referred to as an “application” hereinafter). Note that the term “hold” may be replaced with “store”, “memorize”, or the like.

The display unit 105 is configured to display predetermined information. A liquid crystal panel or the like can be used as an example of the display unit 105. The operation unit 102 and the display unit 105 may be integrated into a touch panel display. This makes it possible to both accept an operation input from the user and display predetermined information. The user can perform a desired operation input to the touch panel display by an operation using a finger (for example, a tap operation, a swipe operation, flick operation, or a pinch operation). Note that the user can also perform an operation input by using an operation element (an electrostatic touch panel pen such as a stylus pen) other than a finger.

As shown in FIG. 1B, the portable terminal 100 includes an OS 107, an application 108, and an application 109. The OS 107 is basic software that is executed by the CPU 101 to implement control on the overall system of the portable terminal 100 and each function.

The application 108 is a storage application for downloading a desired application into the portable terminal 100. The user can download and install a desired application selected from several applications into the portable terminal 100 using the application 108 by performing an operation input concerning password authentication, an operation input concerning the “download” button, and the like. Note that the user can also activate an installed application in the portable terminal 100 by performing an operation input with respect to the “open” button on the screen displayed by the storage application 108.

The application 109 is a function execution application that is installed in the portable terminal 100 by the storage application 108 and executes the function based on a job transmitted to external equipment (a printer or the like) with which the portable terminal 100 can communicate. An example of the job is a print job for causing the printer having a print function to execute printing. Another example is a scan job for causing the printer to execute scanning when the printer further has a scan function. The function execution application 109 may have another known function.

The OS 107 executes the applications 108 and 109. Note that the software including the applications 108 and 109 is generally held in the storage device 106 and is executed by the CPU 101 upon being deployed in the memory 104.

FIG. 5 shows an example of a screen displayed as the setting screen of the OS 107 on the display unit 105. The function execution application 109 is configured to select and set one of a plurality of display languages on the setting screen of the OS 107. Accordingly, if, for example, the user can use various languages, the user can change the language for each application purpose. This can improve the usability. If no display language is set for the function execution application 109, the set language of the OS 107 is used as the display language of the function execution application 109.

In this case, the set language of the function execution application 109 is sometimes expressed as an application set language, and the set language of the OS 107 is sometimes expressed as an OS set language. The application set language is a language displayed on the display unit 105 when the function execution application 109 is used. The OS set language is a language displayed on the display unit 105 for the OS 107. Assume that an application set language and an OS set language can be independently set, and the user can use various languages as described above. In this case, as these languages, different languages can be set.

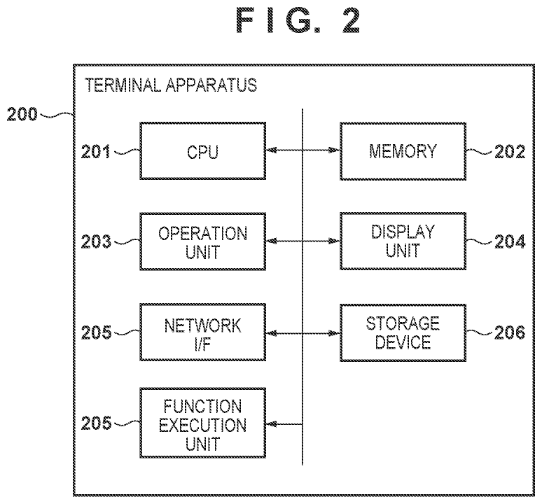

FIG. 2 is a block diagram showing an example of the configuration of a terminal apparatus 200 represented by a printer or the like. The terminal apparatus 200 includes a CPU 201, a memory 202, an operation unit 203, a display unit 204, a network interface 205, a storage device 206, and a function execution unit 207, which are connected to each other via a system bus. The CPU 201 controls the overall system of the terminal apparatus 200.

The memory 202 is, for example, a DRAM capable of holding data under power supply from a data backup power supply and can hold program control variables and the like without volatilizing them. In addition, the memory 202 functions as the main memory and the work memory of the CPU 201 and temporarily holds a print job received from the portable terminal 100 and other pieces of information.

The operation unit 203 is an interface for accepting operation inputs, such as a data input and an instruction, from the user and can be constituted by a keyboard, button type switches, and the like. The display unit 204 includes a known light-emitting element such as a light-emitting diode (LED) and a display such as liquid crystal display (LCD) and displays or notifies the state of the terminal apparatus 200 and data. The operation unit 203 and the display unit 204 may be integrated as a touch panel display like the operation unit 102 and the display unit 105.

The network interface 205 is an interface for connection to a network. This enables the terminal apparatus 200 to communicate with external equipment such as the portable terminal 100.

The storage device 206 holds permanent data such as control programs, data tables, and an OS executed by the CPU 201. The programs held in the storage device 206 perform software execution control such as scheduling, task switching, and interrupt processing under the control of the OS installed in the storage device 206. Assume that the storage device 206 is provided with a memory area holding data that needs to be held in the absence of power supply, such as set information, management data, and the like of the terminal apparatus 200.

The function execution unit 207 executes a function of the terminal apparatus 200, for example, a print function. With this operation, for example, printing is performed on a paper material or a sheet-like recording medium using a recording material such as ink based on information held in the memory 202, a print job from the portable terminal 100, and the like. In addition, the print result is output or displayed via the display unit 204.

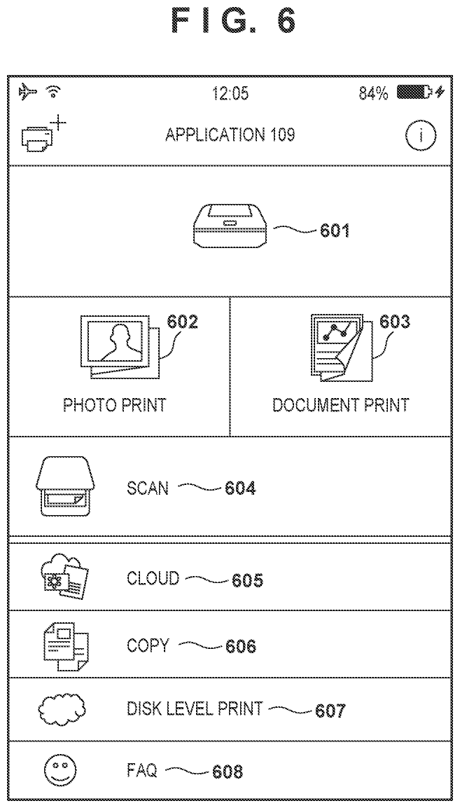

FIG. 6 shows an example of a screen displayed on the display unit 105 as the display screen of the function execution application 109. This screen indicates a plurality of icons such as an icon 601.

The icon 601 will be described in detail later. The icon 601 indicates a printer (to be referred to as the “registered printer” hereinafter) registered in the function execution application 109. Icons 602 and 603 are configured to accept print execution instructions for photos and documents saved in the portable terminal 100. A print job is transmitted to the registered printer based on such an instruction. An icon 604 is configured to accept a scan execution instruction. A scan job is transmitted to the registered printer based on this instruction.

An icon 605 is configured to accept an execution instruction for a cloud print function. Using this icon can cause a printer to print image data on the cloud (image data held in an external server) based on this instruction. An icon 606 is configured to accept an execution instruction for document duplication (copying). A copy job is transmitted to the registered printer based on this instruction.

An icon 607 is configured to accept a print execution instruction for disk media. A print job is transmitted to the registered printer based on this instruction. For printing on a disk medium, for example, an application (disk media print application) different from the function execution application 109 is sometimes required. In such a case, the other application may be installed in the portable terminal 100, and the CPU 101 activates the other application in response to the acceptance of an operation input with respect to the icon 607.

An icon 608 is configured to accept a request instruction for a description/introduction of an operation method or the like for the function execution application 109. The user is guided to a predetermined service (an Internet service such as a Web site) based on this instruction.

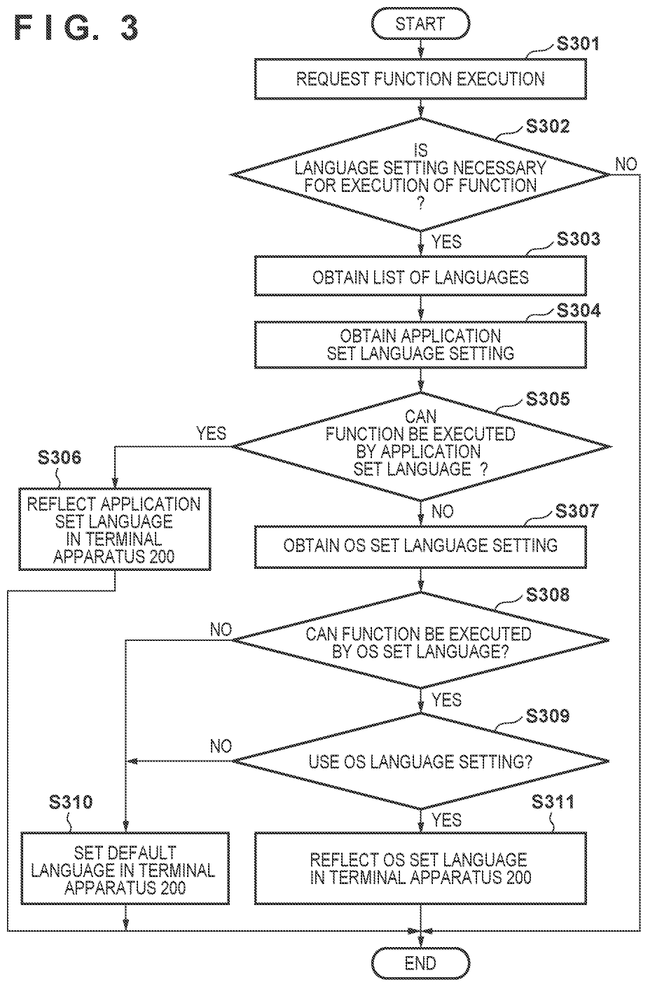

FIG. 3 is a flowchart showing an example of processing for language setting for the terminal apparatus 200 when the portable terminal 100 transmits a job indicating a request for function execution to the terminal apparatus 200 at the time of an operation of the function execution application 109. The CPU 101 mainly executes this flowchart by reading out the program of the function execution application 109 from the storage device 106 and deploying the program in the memory 104. The flowchart is started while the screen for executing the function of the function execution application 109 is displayed on the display unit 105. Language information indicated at the time of this display operation may be a language code based on an international standard complying with ISO 639 or a character string or numerical value that can be commonly processed by the function execution application 109 and the terminal apparatus 200.

As described above, assume that the function execution application 109 includes a print instruction function of instructing a printer with which the portable terminal 100 can communicate to execute printing, and the terminal apparatus 200 is a printer. The function execution application 109 searches for printers around the portable terminal 100 and registers, as a registered printer, one of the printers specified by the search which should execute printing, thereby executing each function (for example, the print function) exemplarily shown in FIG. 6. The registered printer is displayed by the icon 601.

In step S301 (to be simply referred to as “S301” hereinafter; the same applies to other steps (to be described later)), the function execution application 109 of the portable terminal 100 issues a request for function execution to the terminal apparatus 200.

In S302, the function execution application 109 determines the necessity of language setting in the terminal apparatus 200 in executing the requested function. In executing the requested function, if it is necessary to perform language setting in the printer, the process advances to S303 (in which language setting (to be describe later) is performed). If it is not necessary to perform language setting, the flowchart is terminated (language setting is not performed).

Note that an example of a function requiring language setting in the terminal apparatus 200 is a function of performing initialization in a printer. However, this example may be another function requiring output or display of a language on the terminal apparatus 200.

In S303 (if it is necessary to perform language setting in the printer in executing the requested function), information indicating a list of set languages for which the requested function can be executed is obtained. The information indicating this list is obtained from the terminal apparatus 200 but may be registered in advance in the function execution application 109.

In S304, the CPU 101 obtains the information of the set language in the function execution application 109. As described above, since an application set language and an OS set language can be independently set, different languages are sometimes set in the application and the OS by user operations.

In S305, the list of set languages obtained in S303 is compared with the application set language obtained in S304 to determine whether the requested function can be executed. If it is determined that the function can be executed, the process advances to S306; otherwise, the process advances to S307.

In S306, the same language as the application set language obtained in S304 is set for the terminal apparatus 200 (the application set language is reflected in the terminal apparatus 200). In this embodiment, the information indicating the set language in the terminal apparatus 200 is held in the storage device 206 via the network interfaces 103 and 205, with the language code defined in ISO 639-1 being a character string. Assume that language setting for the terminal apparatus 200 has already been completed, and the set language is the same as the set language in the function execution application 109. In this case, this step can be omitted.

In S307, the CPU 101 obtains the information of the set language in the OS 107. As described above, since an application set language and an OS set language can be independently set, different languages are sometimes set in the application and the OS.

In S308, the list of set languages obtained in S303 is compared with the OS set language obtained in S307 to determine whether the request function can be executed. If it is determined that the function can be executed, the process advances to S309; otherwise, the process advances to S310.

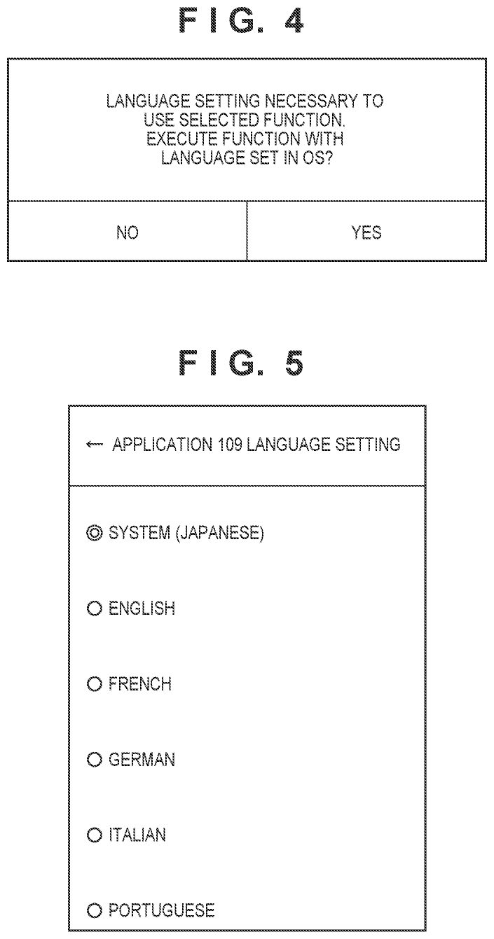

In S309, it is determined, based on the OS set language obtained in S307, whether the requested function is executed. In this case, the dialog screen exemplarily shown in FIG. 4 is displayed on the display unit 204 to prompt the user to determine whether to execute the function based on the OS set language. This dialog screen allows the user to select an OS set language. If the user selects YES (“YES” is selected), the process advances to S311; otherwise (“NO” is selected), the process advances to S310.

In S310, a language that is not the application set language obtained in S304 or the OS set language obtained in S307 and is included in the list of set languages obtained in S303 is set for the terminal apparatus 200. The language set in this case may be the one that is always included in the list of set languages obtained in S303 and is set or registered in advance for default in the function execution application 109 (to be referred to as a “default language” hereinafter). The default language is typically English but may be another language.

Note that whether to approve the setting may be determined by comparing the list of set languages obtained in S303 with the default language. If it is determined that the setting is not approved, a list of set languages which allows the user to select a language to be set may be displayed on the display unit 105. Alternatively, a list of set languages which allows the user to select a language to be set may be displayed on the display unit 105 without setting of a default language itself.

In S311, the same language as the OS set language obtained in S307 is set for the terminal apparatus 200 (the OS set language is reflected in the terminal apparatus 200). In this embodiment, the information indicating the set language in the terminal apparatus 200 is held in the storage device 206 via the network interfaces 103 and 205, with the language code defined in ISO 639-1 being a character string. Assume that language setting in the terminal apparatus 200 has already been completed, and the set language is the same as the set language in the OS 107. In this case, this step can be omitted.

After the language setting in the terminal apparatus 200 is completed in this manner, the function requested for the terminal apparatus 200 can be executed.

According to the above flowchart, when an execution instruction is issued with respect to a function requiring language setting in the terminal apparatus 200 via the portable terminal 100, a language can be properly output or displayed on the terminal apparatus 200. Accordingly, a product based on the execution of a function of the terminal apparatus 200 can be obtained properly (without the occurrence of character corruption, confusion, and the like).

In this embodiment, the function execution application 109 is installed in the portable terminal 100 by the storage application 108. However, this application may be installed in other forms. For example, the function execution application 109 may be installed from a predetermined storage medium or may be installed in advance. Alternatively, the function execution application 109 may be downloaded and installed by using a predetermined Internet service (typically, a Web page). In addition, this installation may be performed by a predetermined installer. Although this embodiment has exemplified the function execution application as the application 109, this application may be an application having another function. In this case, the terminal apparatus 200 may correspond to the function of this application.

### (Program)

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

### (Others)

In the embodiment, individual elements are named by expressions based on their main functions. However, the functions described in the embodiment may be sub-functions, and the expressions are not strictly limited. Furthermore, the expressions can be replaced with similar expressions. In the same vein, an expression “unit (portion)” can be replaced with an expression “tool”, “component”, “member”, “structure”, “assembly”, or the like. Alternatively, these may be omitted or added.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-056355, filed on Mar. 30, 2023, which is hereby incorporated by reference herein in its entirety.

What is claimed is:

1. A control method for an information processing apparatus in which an application that is configured to operate on an operating system (OS) and has a function concerning a setting for function execution of external equipment, the method comprising:
obtaining information concerning a first language set for the application; and
executing language setting for the external equipment by using the obtained information of the first language set for the application in setting for the function execution.

2. The method according to claim 1, further comprising:
obtaining information of a second language set for the OS when no language is set for the application; and
setting a language for the external equipment by using the obtained information of the second language set for the OS in setting for the function execution.

3. The method according to claim 2, further comprising setting a language for the external equipment by using a third language different from the first and second languages in a case where the external equipment does not correspond to the obtained second language.

4. The method according to claim 3, wherein the third language is English.

5. The method according to claim 1, further comprising:
determining whether the external equipment corresponds to the first language; and
setting the first language for the external equipment by transmitting the information of the first language to the external equipment if it is determined that the external equipment corresponds to the first language.

6. The method according to claim 1, wherein the application further comprises transmitting a job for executing the function to the external equipment based on a fact that setting for the function execution is completed.

7. The method according to claim 6, wherein the external equipment is configured to output or display a result of processing of the job.

8. The method according to claim 1, wherein the external equipment is a printing apparatus.

9. A non-volatile computer-readable storage medium storing a program, the program configured to cause a computer to perform each step of the method according to claim 1.
